(19) United States
(12) Patent Application Publication
(10) Pub. No.: US 2007/0083508 A1
(43) Pub. Date: Apr. 12, 2007

(54) DOCUMENT SEARCH APPARATUS AND METHOD

(75) Inventor: Satoru NAKAJIMA, Ohta-ku, Tokyo (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/539,360

(22) Filed: Oct. 6, 2006

(30) Foreign Application Priority Data
Oct. 12, 2005 (JP) 2005-298101

(51) Int. Cl. G06F 17/30

(52) U.S. Cl. 707/5

(57) ABSTRACT

A document search apparatus having a storage unit configured to store document data, and an interface unit configured to display information to the user and to allow the user to input an instruction is provided. When another apparatus having at least a memory unit is connected and the user designates a search in a predetermined search mode, this document search apparatus receives information of previous search results from the other apparatus, conducts the search in the predetermined search mode using the information of the previous search results, and displays search results in the predetermined search mode by changing the display mode of the search results based on the information of the previous search results.

### BACKGROUND OF THE INVENTION

1. Field of the Invention

The present invention relates to a document search apparatus and method and, more particularly, to a display technique in a search mode which uses previous search results stored in another apparatus in a document search apparatus that stores document data and searches for document data in accordance with a user instruction.

2. Description of the Related Art

In recent years, multi-function apparatuses (to be referred to as a digital multi-function peripheral (MFP) hereinafter) prepared by appending a large number of functions to a digital copying machine as a base are commercially available. More specifically, the following functions are appended: a function of making a facsimile communication using a scanner and printer which are originally equipped in the digital copying machine; a function of rasterizing code data sent from a computer into bitmap data and printing the bitmap data using the printer; a function of sending an image scanned from the scanner onto the network using the scanner; a function of printing an image distributed from the network using the printer; and the like.

As one of such functions, a personal box function is available. This function assigns areas (personal boxes) of a storage device of the digital MFP in correspondence with individual users and departments, stores data of print images and scan images as document files in these areas, and can output them as needed.

Nowadays, a document management function which allows the user to refer to such personal boxes on the network, and to share and use documents stored in the personal boxes of a plurality of digital MFPs connected via a network has been proposed.

This function allows the user to search documents stored in a plurality of digital MFPs connected via a network in accordance with an instruction from an operation screen on a given digital MFP so as to refer to or print a desired document on the MFP that he or she is operating.

As for display of search results, Japanese Patent Laid-Open No. 2003-345810 describes that a server-client document search system determines a category class according to the search results, and classifies and displays the search results according to the category class using a graph or the like.

However, a problem is posed when the conventional digital MFP is used to search documents stored in a plurality of digital MFPs connected via a network, and the number of hit documents is large. For example, when a search is conducted based on an arbitrary keyword using a search engine, if the number of hit documents is large, it is difficult for the user to find a desired document from a list of search results, thus requiring much labor. Especially, since the display region of the operation screen of the MFP is limited, the usability drops if the number of hit documents is large.

On the other hand, as general document search means on a network, a search system of a site on a WWW (World Wide Web) is known. With this search system, the user inputs a search instruction from application software called a Web browser used to browse a Web site, and executes a search using a search engine or the like. Then, the Web browser displays, as search results, URLs (Uniform Resource Locators) as information storage locations in the HTML (Hyper Text Markup Language) format. The Web browser holds the browse log, and can change the display color of the URL of the already browsed information.

However, since the information of the browse log in the search system on the WWW is held in each terminal, if the identical user uses another terminal, he or she cannot reflect the information of the browse log to his or her next search.

Likewise, as for a search in a plurality of digital MFPs connected via a network, when a search is conducted in an MFP different from the MFP used to execute the previous search, the information of the browse log cannot be reflected.

Furthermore, it is demanded to transmit information of its search results in a digital MFP or the like to a portable device, and to allow that portable device or a computer apparatus connected to the portable device to browse the search results as needed. In such case as well, it is desirable to reflect the browse log in the portable device or the computer apparatus connected to the portable device.

The aforementioned problems are not limited to only the digital MFPs but are common to various document search systems including a document search apparatus (computer apparatus) and at least storage means.

### SUMMARY OF THE INVENTION

It is an object of the present invention to solve the problems of the prior arts.

A characteristic feature of the present invention lies in that new search results are displayed by reflecting previous search results stored in another apparatus.

According to one aspect of the present invention, a document search apparatus having a storage unit configured to store document data, and an interface unit configured to display information to the user and to allow the user to input an instruction is provided. When another apparatus having at least a memory unit is connected and the user designates a search in a predetermined search mode, this document search apparatus receives information of previous search results from the other apparatus, conducts the search in the predetermined search mode using the information of the previous search results, and displays search results in the predetermined search mode by changing the display mode of the search results based on the information of the previous search results.

Further features of the present invention will become apparent from the following description of exemplary embodiments with reference to the attached drawings.

### BRIEF DESCRIPTION OF THE DRAWINGS

FIG. 1 is a schematic diagram for explaining the overall arrangement of an embodiment of a document search system according to the present invention;

FIG. 2 is a block diagram for explaining the overall arrangement of a digital MFP shown in FIG. 1;

FIG. 3 is a plan view showing the arrangement of a console of the digital MFP shown in FIG. 1;

FIG. 4 is a block diagram showing the functional arrangement of system software in a controller unit of the digital MFP shown in FIG. 2;

FIG. 5 is a flowchart showing the overall operation of document search processing in the embodiment of the present invention;

FIG. 6 is a flowchart of search instruction input processing in FIG. 5;

FIG. 7 is a flowchart of search execution processing in FIG. 5;

FIGS. 8A and 8B show definition examples of management tables of search result information to be sent to a portable device;

FIG. 9 is a flowchart of search result display processing in FIG. 5;

FIG. 10 is a flowchart of newly-arrived document display processing in FIG. 9;

FIG. 11 is a flowchart of new document extraction processing in FIG. 10;

FIG. 12 is a flowchart of unread document display processing in FIG. 9; and

FIG. 13 is a flowchart of unread document extraction processing in FIG. 12.

### DESCRIPTION OF THE EMBODIMENTS

Preferred embodiments of the present invention will be described hereinafter with reference to the accompanying drawings. The embodiments to be described hereinafter do not limit the present invention according to the scope of the claims, and all combinations of the features described in the embodiments are not always indispensable to solving means of the present invention.

Note that term “connection” in this specification means that two or more apparatuses are electrically coupled to be able to exchange (communicate) information, and the media used in coupling may be a wired, wireless, or optical medium.

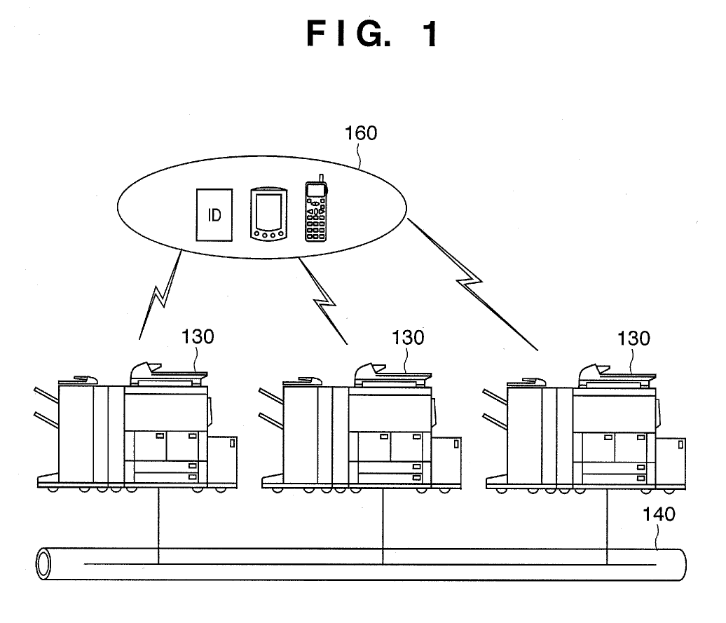

FIG. 1 is a schematic diagram for explaining the overall arrangement of an embodiment of a document search system according to the present invention. This document search system comprises digital MFPs 130 and portable devices 160. A plurality of digital MFPs 130 can be connected via a network 140. Each of the portable devices 160 can communicate with the digital MFPs 130 using a wireless or wired communication, and comprises at least a memory unit. FIG. 1 exemplifies an ID card, PDA, and portable phone, but the present invention does not depend on specific apparatuses.

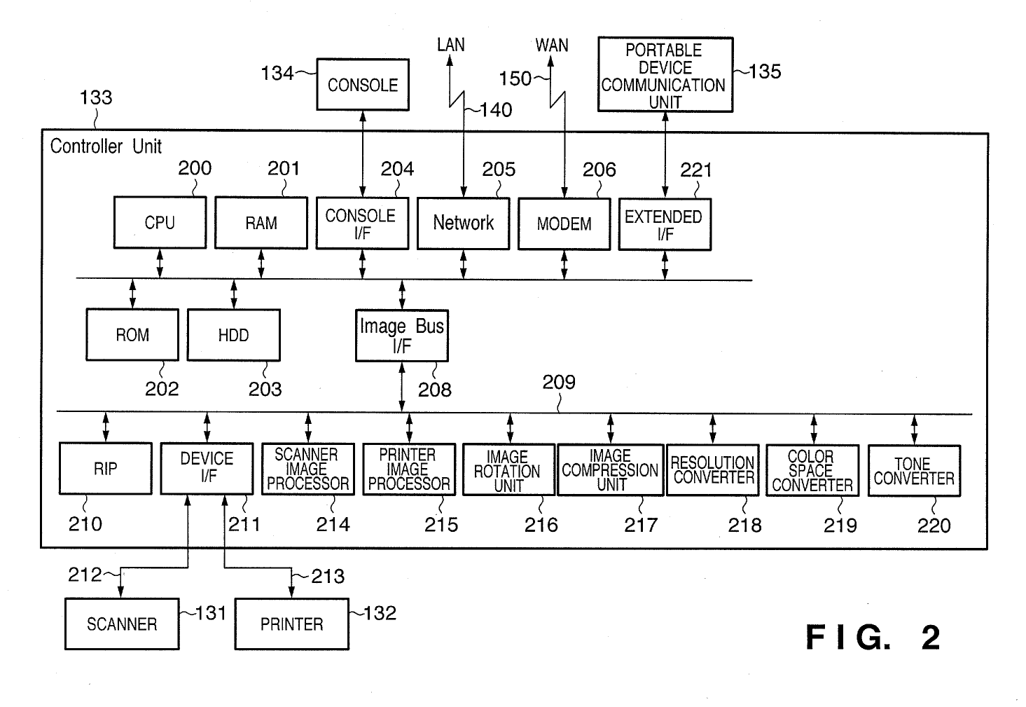

FIG. 2 is a block diagram for explaining the overall arrangement of the digital MFP shown in FIG. 1. A controller unit 133 serves as a controller used to input and output image information and device information. For this reason, the controller unit 133 is connected to a scanner unit 131 as an image input device and a printer unit 132 as an image output device, and is also connected to a network and public line such as a LAN 140, WAN 150, and the like.

In the controller unit 133, reference numeral 200 denotes a CPU which controls the overall system. Reference numeral 201 denotes a RAM which serves as a system work memory required to operate the CPU 200 and also an image memory (buffer memory) used to temporarily store input image data. Reference numeral 202 denotes a boot ROM which stores a boot program of the system. Reference numeral 203 denotes a hard disk drive (HDD) which stores system software and image data.

Reference numeral 204 denotes a console I/F which serves as an interface with a control 134, and outputs image data and information of the image data to be displayed on the console 134. Also, the console I/F 204 serves to transfer information input by the user from console 134 to the CPU 200.

Reference numeral 205 denotes a network unit which is connected to the network such as the LAN 140 or the like to input and output information. Reference numeral 206 denotes a modem (MODEM) which is connected to the public line such as the WAN 150 or the like to input and output image information. Reference numeral 221 denotes an extended I/F which serves as an interface unit with a portable device communication unit 135, and outputs information from the console 134 or information stored in the HDD 203 to the portable device communication unit 135. Also, the extended I/F 221 serves to transfer information received from the portable device via the portable device communication unit 135 to the CPU 200. The aforementioned devices are arranged on a system bus 207.

Reference numeral 208 denotes an image bus (Image Bus) I/F serving as a bus bridge which connects the system bus 207 and an image bus 209 that transfers image data at high speed, and converts data structures. The image bus 209 comprises a PCI bus or IEEE1394. The following devices are arranged on the image bus 209.

Reference numeral 210 denotes a raster image processor (RIP) which rasterizes PDL code data into bitmap image data. Reference numeral 211 denotes a device I/F which connects the scanner unit 131 and printer unit 132 as image input and output devices, and the controller unit 133 via an image input unit interface 212 and printer unit interface 213, respectively to convert synchronization/asynchronization of image data. Reference numeral 214 denotes a scanner image processor which corrects, modifies, and edits input image data. The scanner image processor 214 has a function of determining based on a saturation signal of an image whether the input image is a color or monochrome image, and holding the determination result. Reference numeral 215 denotes a printer image processor which corrects, modifies, and edits output image data.

Reference numeral 216 denotes an image rotation unit which rotates an image simultaneously with scanning of the image from the scanner unit 131 in collaboration with the scanner image processor 214 and stores the rotated image on a memory, or rotates an image on the memory. The image rotation unit 216 can print out an image to be stored on the memory or an image already stored on the memory while rotating that image in collaboration with the printer image processor 215. Reference numeral 217 denotes an image compression unit which executes compression/decompression processing of multi-valued image data based on JPEG or binary image data based on JBIG, MMR, MR, or MH. Reference numeral 218 denotes a resolution converter which applies resolution conversion processing to an image on the memory, and stores it on the memory. Reference numeral 219 denotes a color space converter which converts, e.g., a YUV image on the memory into an Lab image by matrix calculations, and stores it on the memory. Reference numeral 220 denotes a tone converter which converts, e.g., an 8-bit, 256-tone image on the memory into a 1-bit, binary image using for example an error diffusion processing, and stores it on the memory. The image rotation unit 216, image compression unit 217, resolution converter 218, color space converter 219, and tone converter 220 can operate in collaboration with each other. For example, when an image on the memory is to undergo image rotation and resolution conversion, these two processes can be done without the intervention of the memory.

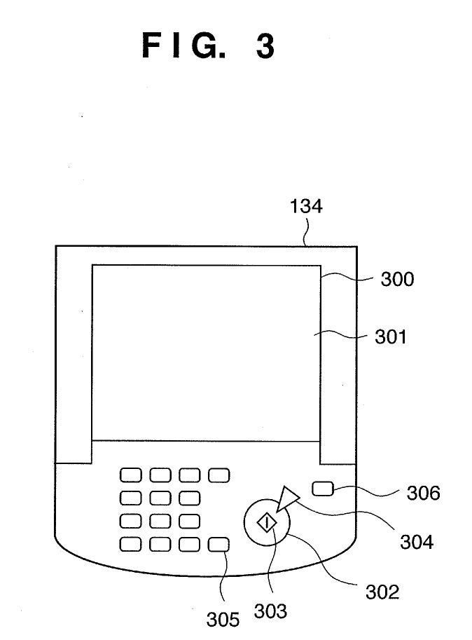

FIG. 3 shows the arrangement of the console 134 of the digital MFP. An LCD display 300 is prepared by adhering a touch panel sheet 301 on an LCD, and displays an operation window of the system and software keys. Upon pressing of one of the displayed keys, the LCD display 300 informs the CPU 200 in the controller unit 133 of its position information. A start key 302 is used upon, e.g., starting the scan operation of an original image. The central portion of the start key 302 includes two-color, i.e., green and red LEDs 303, which indicate whether or not the start key 302 is ready to use depending on their colors. A stop key 304 serves to stop an active operation. An ID key 305 is used to input a user ID of the user. A reset key 306 is used to reset the setting from the console.

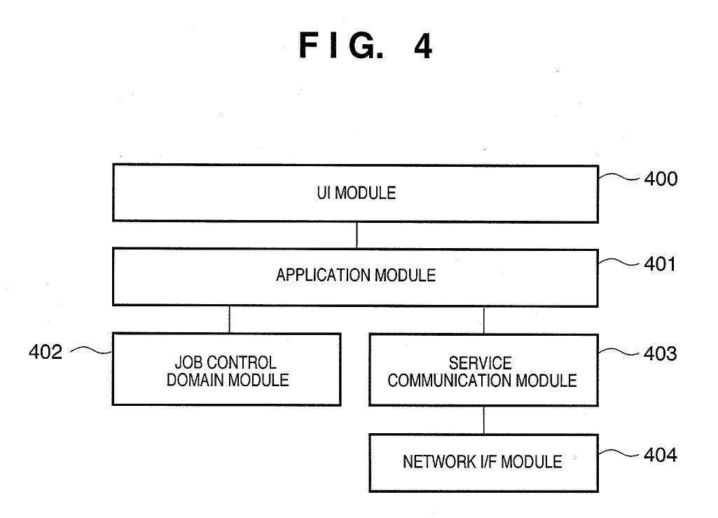

FIG. 4 is a block diagram showing the functional arrangement of system software in the controller unit 133 of the digital MFP shown in FIG. 2.

A user interface (UI) module 400 supplies input information from the user to an application module 401, and receives the processing result from the application module 401 and generates a window to be displayed on the console 134. The application module 401 executes processing in accordance with a request from the user interface (UI) module 400. Upon reception of a scan or print request, the application module 401 inputs a job to a job control domain module 402 together with the designated settings. Also, the application module 401 receives information such as device status, job status, and the like from the job control domain module 402. Furthermore, upon reception of a document search request, the application module 401 supplies that request to a service communication module 403, and receives that processing result.

The job control domain module 402 controls processing of a plurality of jobs such as a scan job, copy job, print job, FAX job, and the like. The service communication module 403 sends a request command to another digital MFP via a network I/F module 404 using a SOAP protocol on the HTTP protocol, and receives its response. The network I/F module 404 connects the network such as the LAN 140 or the like, and executes processing of a network protocol such as TCP/IP or the like.

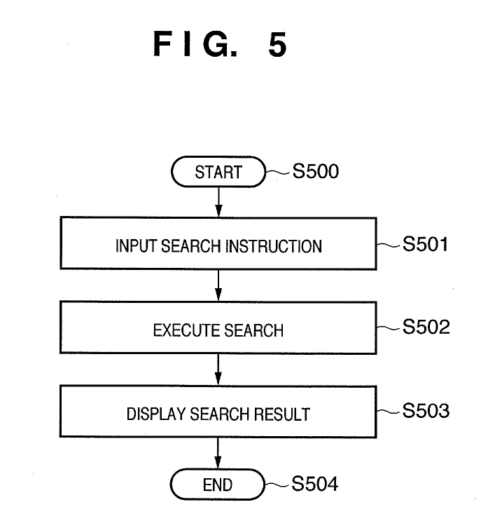

The overall operation of the document search processing will be described below with reference to the flowchart of FIG. 5.

This processing starts (step S500) when the user operates the console 134. The control displays a window used to input a search instruction by the user. The user makes desired settings and inputs according to displayed messages to input a search instruction (step S501). The control conducts a search according to the input instruction (step S502), and displays search results on the console 134 (step S503), thus ending the processing (step S504). Steps S501 to S503 will be described in detail below.

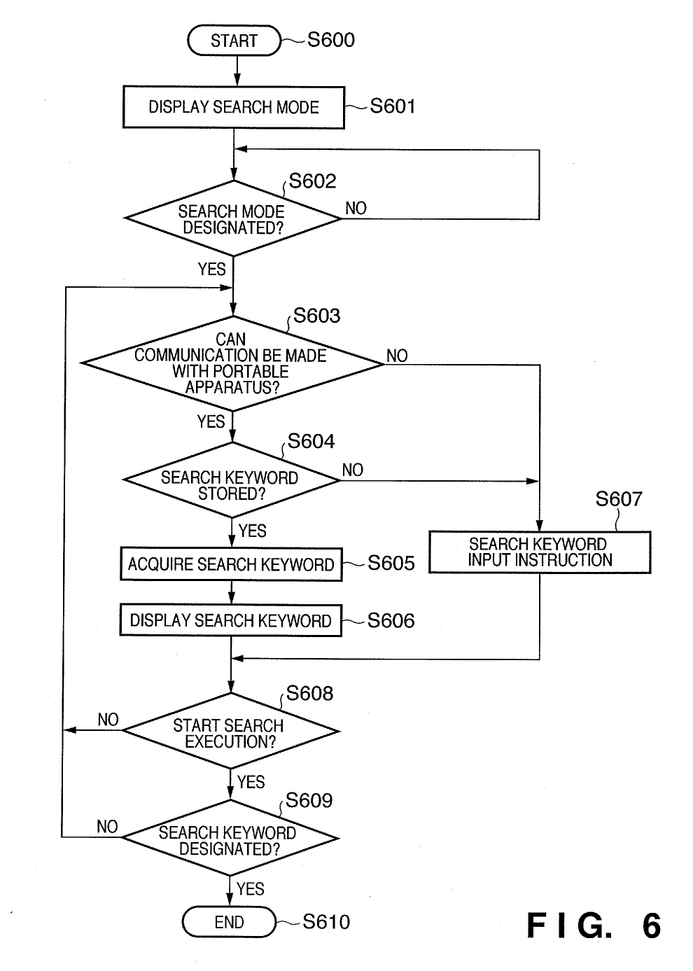

The search instruction input processing in step S501 will be described in detail first with reference to the flowchart of FIG. 6.

When the search instruction input processing starts (step S600), the control displays a window used to select a search mode on the console 134 (step S601). A display method for further narrowing down found document information is determined based on the search mode. As the types of search modes, for example, a “newly-arrived document search mode”, “unread document search mode”, “read document search mode”, and the like are available. The “newly-arrived document search mode” conducts a search using the same search keyword as in the previous search, and displays differences from the previous search, i.e., information of new documents found by the current search. The “unread document search mode” displays information of documents which have not been referred to by the user previously from the search results. The “read document search mode” displays information of documents which have already been referred to by the user previously from the search results. Note that this embodiment has, as the search modes, the newly-arrived document search mode, the unread document search mode, and a full document display mode as a default mode.

If the user selects the search mode (step S602), the control checks if a communication with the portable device can be made, i.e., if the user makes the portable device communication unit 135 recognize the portable device to be able to input and output information (step S603). If a communication with the portable device can be made, the control inquires whether or not the portable device stores a search keyword (step S604). If the portable device stores a search keyword, the control acquires the search keyword, and displays that keyword on the console 134 (step S606) . If the portable device stores a plurality of search keywords, the control may display these keywords so that one or a plurality of keywords are selectable from them.

On the other hand, if it is determined in step S603 that a communication with the portable device cannot be made, the control displays a window that prompts the user to input a new search keyword on the console 134 (step S607). If it is determined in step S604 that a communication with the portable device can be made but the portable device does not store any search keyword, the process advances to step S607.

After the control displays the search keyword in step S606 or it displays the search keyword input window in step S607, the control waits for a user's search execution instruction (step S608). If the user instructs execution, the control checks if a search keyword is designated (step S609). If a search keyword is designated, the processing end (step S610). If no search keyword is designated, the control returns to step S603 to repeat the subsequent processes.

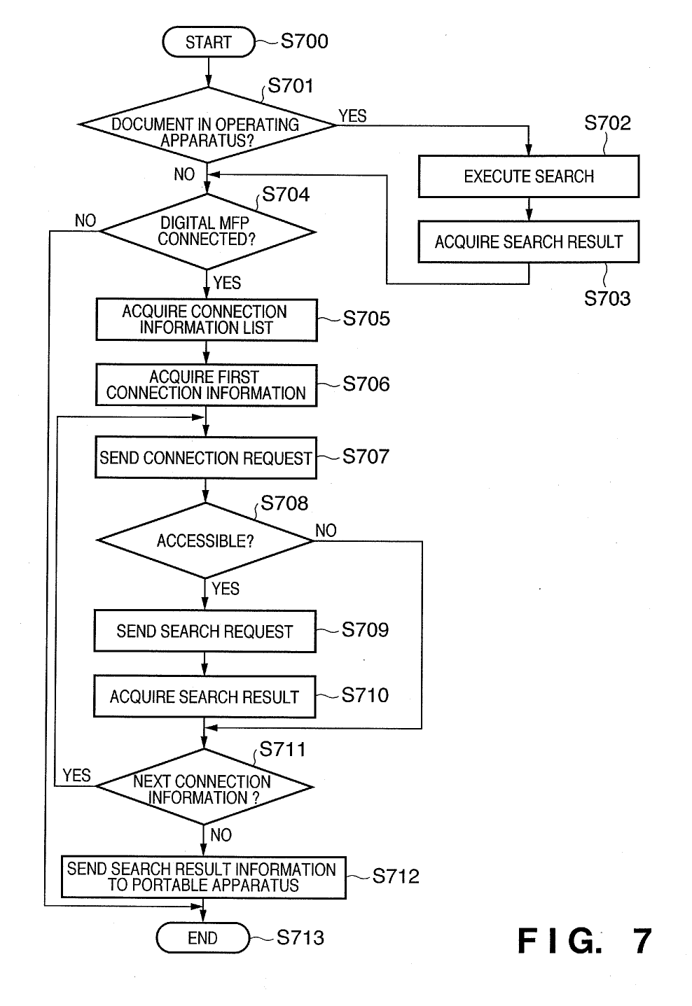

The search execution processing in step S502 will be described in detail below with reference to the flowchart of FIG. 7.

Upon starting execution of a search (step S700), the control checks if the digital MFP that the user operates stores documents (step S701) If the digital MFP stores documents, the control conducts a search using a search engine of the system software (step S702) and acquires search results (step S703). If the digital MFP does not store any documents, or if the search of documents in the digital MFP is complete, the control starts search processing of documents stored in other digital MFPs on the network.

The control checks if other digital MFPs are connected to the network (step S704). The control issues an inquiry about the presence of other digital MFPs on the network via the network unit 205 based on the designated information. Upon reception of the inquiry request, each of the digital MFPs on the network sends connection information indicating their presence via the network. If no reply is received from other digital MFPs within a predetermined period of time, i.e., if no digital MFP is present on the network, the processing ends (step S713). On the other hand, if the service communication module 403 receives connection information, i.e., if other digital MFPs are present, the control stores the connection information from each digital MFP as a list (step S705). This connection information includes, e.g., an IP address, unique ID information, or the like as information required to connect that digital MFP.

The control acquires the first connection information from the stored connection information list (step S706), and sends a connection request to the digital MFP having that connection information together with user information (step S707). Upon reception of the connection request, the digital MFP performs user authentication based on the received user information, and returns access permission information. If the service communication module 403 receives the access permission information, the control checks if an access to the digital MFP can be made (step S708). If an access cannot be made, the process jumps to step S711. On the other hand, if an access can be made, the control sends a search request together with the search keyword selected in the search instruction input processing (step S709) . Upon reception of the search request, the digital MFP conducts a document search based on the received search keyword, and returns search result information. If the service communication module 403 receives the search result information, the application module 401 acquires the search result (step S710).

After the processing in step S710 or if it is determined in step S708 that an access cannot be made, the control checks if the stored connection list includes the next connection information (step S711). If the list includes the next connection information, the process returns to step S707 to repeat the subsequent processes. On the other hand, if the list does not include the next connection information, the control sends the search result information to the portable device (step S712), thus ending the processing (step S713).

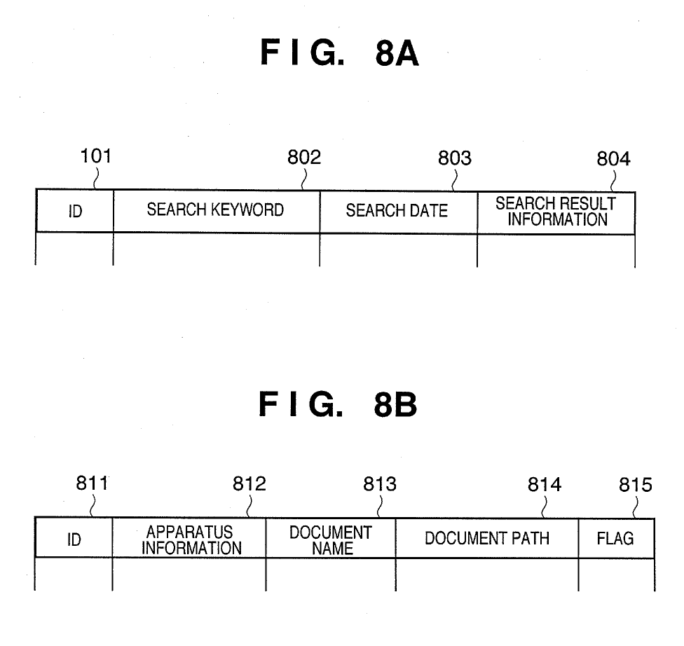

FIGS. 8A and 8B show definition examples of management tables of the search result information to be sent to the portable device. In this embodiment, the digital MFP sends a keyword table and document table to the portable device as the search result information.

The keyword table shown in FIG. 8A indicates information of search results for each search keyword. This table includes a keyword ID 801, search keyword 802, search date 803, and search result information 804. The keyword ID 801 used to identify a search keyword is assigned to identify each keyword. The search date 803 indicates an execution date of the search using the corresponding search keyword. The search result information 804 is an identification information list of documents found by the corresponding search keyword.

The document table shown in FIG. 8B indicates information for each found document. This table includes a document ID 811, apparatus information 812, document name 813, document path 814, and flag 815. The document ID 811 is assigned to identify each document. The apparatus information 812 is used to identify a digital MFP that stores the corresponding document. The document path 814 indicates the storage location of the corresponding document in the digital MFP. The flag 815 indicates whether or not the document is unread or read, and is also called a read flag.

If the portable device has an arrangement comprising display unit and input unit like a portable phone or PDA, document data may be allowed to be displayed on the portable device. In this case, at least one of the search result information 804 of the keyword table and the document ID 811 and document name 813 of the document table includes link information to corresponding information (document) . When the user designates information on the table displayed on the portable device, corresponding document data or a part thereof may be read out according to the link information, and may be displayed on the portable device. In this manner, when the portable device displays at least a part of document information, the flag 815 of the document table is preferably updated to the “read” state.

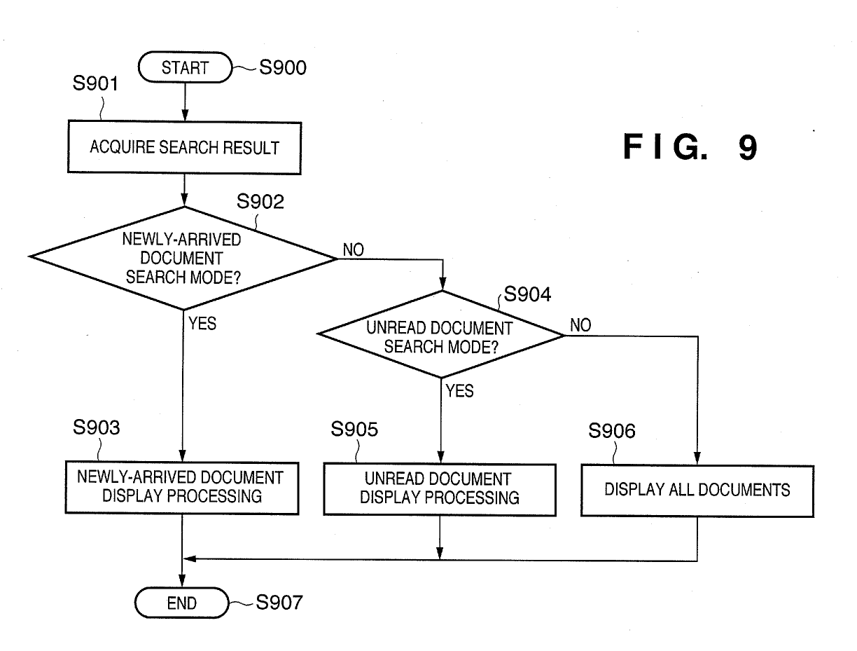

Note that the information of the keyword table and information other than the flag 815 of the document table may be protected so as not to be updated or deleted by the portable device. Alternatively, the user may set items that can be updated or deleted on the digital MFP or portable device. The search result display processing in step S503 will be described in detail below with reference to the flowchart of FIG. 9.

After completion of the search, when display of search results starts (step S900), the control acquires the search results (step S901), and checks if the search mode selected by the user in step S602 is the newly-arrived document search mode (step S902). If the search mode is the newly-arrived document search mode, the control executes newly-arrived document display processing (to be described later) (step S903), thus ending the processing (step S907). If the search mode is not the newly-arrived document search mode, the control checks if the search mode is the unread document search mode (step S904). If the search mode is the unread document search mode, the control executes unread document display processing (to be described later) (step S905), thus ending the processing (step S907) On the other hand, if the search mode is neither the newly-arrived document search mode nor the unread document search mode, the control determines that the search mode is the full document display mode, and displays all pieces of document information of the acquired search results (step S906), thus ending the processing (step S907).

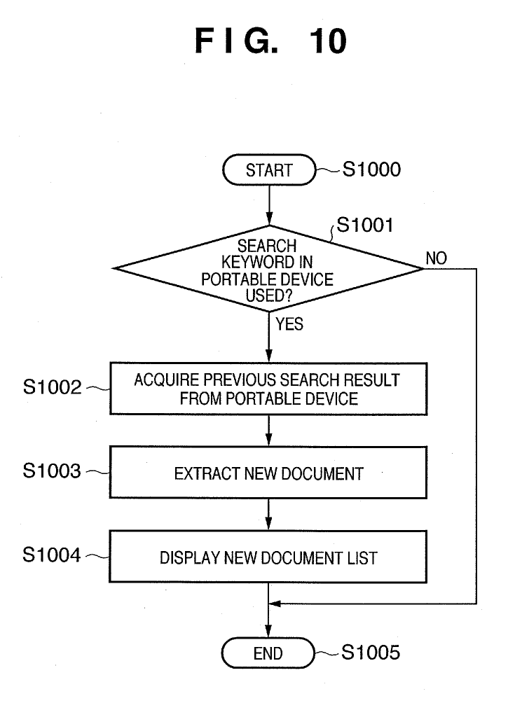

The newly-arrived document display processing executed in step S903 will be described in detail below with reference to the flowchart of FIG. 10. When the newly-arrived document display processing starts (step S1000), the control checks if the search keyword used in the search is that acquired from the portable device (step S1001). If the search keyword used in the search is not that acquired from the portable device, i.e., if it is a new search keyword, the processing ends (step S1005). If the search keyword acquired from the portable device is used, the control acquires the search result information up to the previous search from the portable device (step S1002), and executes newly-arrived document extraction processing (to be described later) (step S1003). The control displays information of extracted documents as a newly-arrived document list (step S1004), thus ending the processing (step S1005).

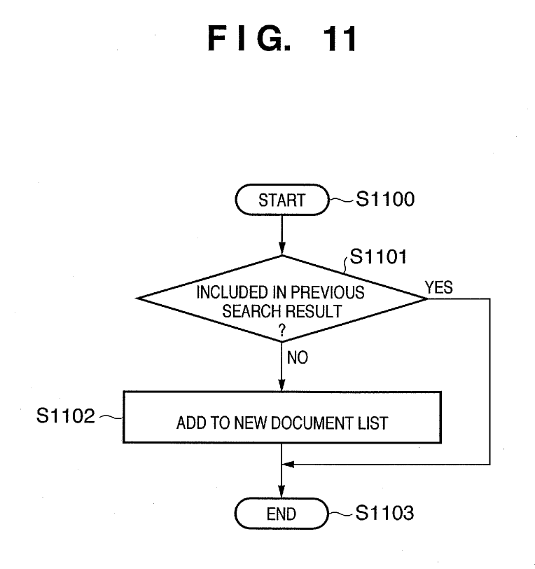

The new document extraction processing executed in step S1003 will be described below with reference to the flowchart of FIG. 11. This processing is executed for each document included in the search result information. When the processing starts (step S1100), the control compares the extracted information with the previous search result information to see if the previous search result information includes information of a document of interest (step S1101). If the previous search result information does not include the information of the document of interest, the control determines that the document of interest is a new document and adds it to a new document list (step S1102), thus ending the processing (step S1103). If the previous search result information includes the information of the document of interest in step S1101, the control does not add that information to the new document list, and ends processing. The control repeats these processes for respective documents included in the search result information, thus obtaining a new document list.

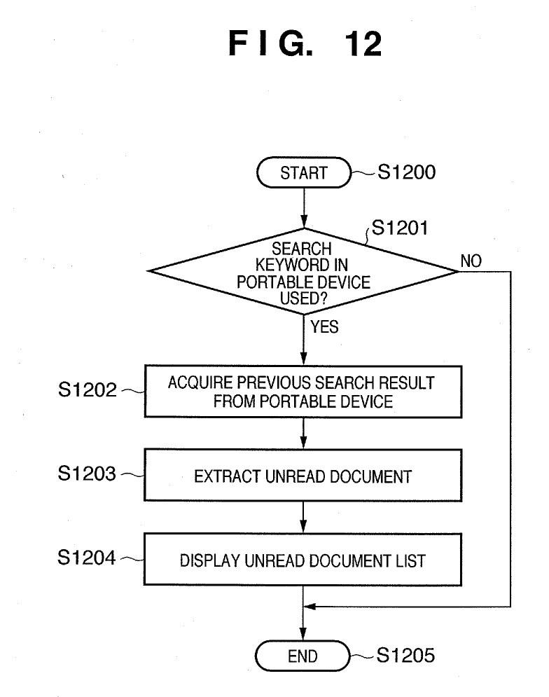

The unread document display processing executed in step S905 will be described in detail below with reference to the flowchart of FIG. 12. When the unread document display processing starts (step S1200), the control checks if the search keyword used in the search is that acquired from the portable device (step S1201). If the search keyword used in the search is not that acquired from the portable device, i.e., if it is a new search keyword, the processing ends (step S1205). If the search keyword acquired from the portable device is used, the control acquires the search result information up to the previous search from the portable device (step S1202), and executes unread document extraction processing (to be described later) (step S1203). The control displays information of extracted documents as a unread document list (step S1204), thus ending the processing (step S1205).

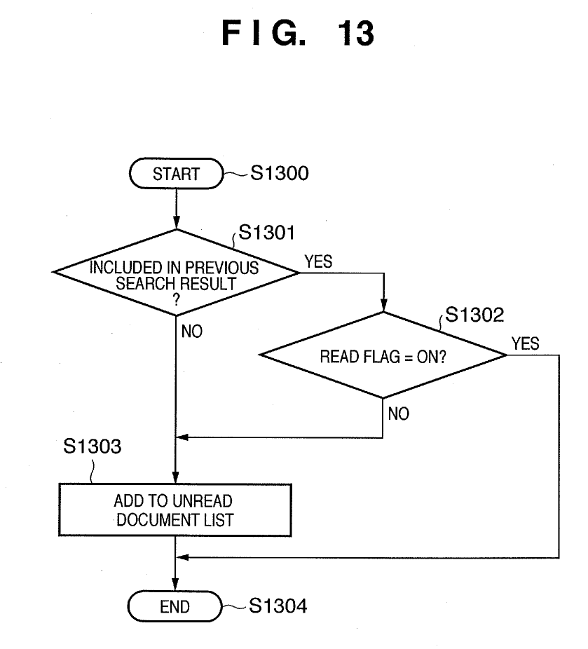

The unread document extraction processing executed in step S1203 will be described below with reference to the flowchart of FIG. 13. This processing is executed for each document included in the search result information. When the processing starts (step S1300), the control compares the extracted information with the previous search result information to see if the previous search result information includes information of a document of interest (step S1301). If the previous search result information does not include the information of the document of interest, the control determines that the document of interest is a unread document and adds it to a unread document list (step S1303), thus ending the processing (step S1304). If the previous search result information includes the information of the document of interest, the control checks with reference to the read flag 815 of the document if the document of interest has already been read. If the read flag is OFF, the control determines that the document of interest is an unread document, and adds it to the unread document list (step S1303), thus ending the processing (step S1304). If the read flag is ON, the control does not add the document of interest to the unread document list, and ends processing (step S1304). The control repeats these processes for respective documents included in the search result information, thus obtaining an unread document list.

(Modification)

In this embodiment, the newly-arrived document display processing extracts and displays only newly-arrived documents. However, other display modes may be adopted. For example, the order of the list may be changed to display newly-arrived documents at the head of the list, or newly-arrived documents may be displayed by changing their display format such as a display color, character size, and font.

Likewise, the unread document display processing extracts and displays only unread documents. However, other display modes may be adopted. The order of the list may be changed to display unread documents at the head of the list, or unread documents may be displayed by changing their display format such as a display color, character size, and font.

In the above description, in the unread document search mode, the procedure of the processing upon extracting or highlighting only unread documents has been explained.

As described above, this embodiment also has the read document search mode, and the processing opposite to the unread document search mode is executed in the read document search mode. That is, only unread documents are displayed or highlighted in the unread document search mode, while only read documents (already referred documents) are extracted, or their display pattern is changed or they are displayed in the top display rank.

Since the above embodiment identifies a newly-arrived, unread, or read search result and the browse log by acquiring the search results up to the previous search from the portable device, common search results can be reflected in the next search results even when a search is conducted using various MFPs. Furthermore, according to the above embodiment, there is no need to provide a server having a search function and a browse function for the search result, and to perform the search and browse via the server.

In addition to the use of the portable device, a server may be connected to the network, and may store information of search results up to the previous search in correspondence with the user information and search keywords, thus obtaining the same effects. In this case, the server can only manage the search results and the browse log. In other words, the server does not need providing the search function and browse function for the search result, or executing these functions. Therefore, the load of the server is not increased.

(Other Embodiments)

Note that the present invention can be applied to a document search apparatus comprising a single device or to a document search system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2005-298101 filed Oct. 12, 2005, which is hereby incorporated by reference herein in its entirety.

What is claimed is:

1. A document search apparatus comprising:
a storage unit configured to store document data;
an interface unit configured to display information to a user and to allow the user to input an instruction;
a search unit configured to search document data in said storage unit in accordance with a user instruction;
a search result display unit configured to display information of a search result by said search unit via said interface unit; and
a communication unit configured to send the information of the search result when another apparatus having at least a memory unit is connected,
wherein when the user designates a search in a predetermined search mode, said communication unit receives information of a previous search result from the other apparatus,
said search unit conducts the search in the predetermined search mode using the information of the previous search result, and
said search result display unit changes a display mode of the information of the search result in the predetermined search mode based on the information of the previous search result.

2. The apparatus according to claim 1, wherein the other apparatus is a portable device.

3. The apparatus according to claim 1, wherein the information of the search result includes information of a keyword, and a list of found document data, and said search unit conducts the search in the predetermined search mode using the information of the keyword included in the information of the previous search result.

4. The apparatus according to claim 1, wherein the predetermined search mode includes a newly-arrived document search mode, and
when the user designates a search in the newly-arrived document search mode, said search result display unit changes the display mode in accordance with a difference between the information of the previous search result and the information of a new search result.

5. The apparatus according to claim 4, wherein when the user designates the search in the newly-arrived document search mode, said search result display unit displays document data alone included in only the new search result.

6. The apparatus according to claim 1, wherein the predetermined search mode includes an unread document search mode,
the information of the search result includes, for each found document data, browse information indicating whether or not detailed information has already been displayed, and
when the user designates the search in the unread document search mode, said search result display unit changes the display mode in accordance with the browse information.

7. The apparatus according to claim 1, wherein the predetermined search mode includes a read document search mode,
the information of the search result includes, for each found document data, browse information indicating whether or not detailed information has already been displayed, and
when the user designates the search in the read document search mode, said search result display unit changes the display mode in accordance with the browse information.

8. The apparatus according to claim 6, wherein the browse information reflects whether or not the other apparatus has already displayed the detailed information of each found document data.

9. The apparatus according to claim 6, wherein when the user designates the search in the unread document search mode, said search result display unit displays only document data whose detailed information has not been displayed yet.

10. The apparatus according to claim 7, wherein when the user designates the search in the read document search mode, said search result display unit displays only document data whose detailed information has already been displayed.

11. The apparatus according to claim 1, wherein said document search apparatus is a digital multi-function peripheral equipment having a copy function, a scanner function, and a print function.

12. A document search system which has a plurality of document search apparatuses connected via a network, and a portable device that has at least a memory unit and can establish connection to one of said plurality of document search apparatuses, each of said document search apparatuses comprising:
a storage unit configured to store document data;
an interface unit configured to display information to a user and to allow the user to input an instruction;
a search unit configured to search document data in the storage units of all said document search apparatuses in accordance with a user instruction;
a search result display unit configured to display information of a search result by said search unit via said interface unit; and
a communication unit configured to send the information of the search result to said portable device,
wherein when the user designates a search in a predetermined search mode at the document search apparatus connected to said portable device,
said communication unit receives information of a previous search result from said portable device,
said search unit conducts the search in the predetermined search mode using the information of the previous search result, and
said search result display unit changes a display mode of the information of the search result in the predetermined search mode based on the information of the previous search result.

13. A document search method for searching, using an information processing apparatus having a storage unit configured to store document data, and an interface unit configured to display information to a user and to allow the user to input an instruction, document data in the storage unit in accordance with a user instruction, the method comprising the steps of:
receiving, when another apparatus having at least a memory unit is connected and the user designates a search in a predetermined search mode, information of a previous search result from the other apparatus;
conducting the search in the predetermined search mode using the information of the previous search result; and
displaying information of a search result in the predetermined search mode by changing a display mode of the information based on the information of the previous search result.

14. A computer program for controlling a document search apparatus including a computer executing the program, a storage unit configured to store document data, and an interface unit configured to display information to a user and to allow the user to input an instruction, the program comprising code for performing the following steps:
receiving, when another apparatus having at least a memory unit is connected and the user designates a search in a predetermined search mode, information of a previous search result from the other apparatus;
conducting the search in the predetermined search mode using the information of the previous search result; and
displaying information of a search result in the predetermined search mode by changing a display mode of the information based on the information of the previous search result.
